(19) United States
(12) Patent Application Publication
(10) Pub. No.: US 2015/0033045 A1
(43) Pub. Date: Jan. 29, 2015

(54) Power Supply Droop Reduction Using Feed Forward Current Control

(71) Applicant: Apple Inc., Cupertino, CA (US)

(72) Inventors: Pankaj Raghuvanshi, San Jose, CA (US); Rohit Kumar, Santa Clara, CA (US); Suresh Periyacheri, Austin, TX (US)

(73) Assignee: Apple Inc., Cupertino, CA (US)

(21) Appl. No.: 13/948,843

(22) Filed: Jul. 23, 2013

(51) Int. Cl. G06F 1/32

(52) U.S. Cl. CPC G06F 1/3234
USPC 713/320

(57) ABSTRACT

An apparatus for performing instruction throttling for a computing system is disclosed. The apparatus may include a first counter, a second counter, and a control circuit. The second counter may be configured to increment in response to a determination that a processing cycle of a processor has completed. The control circuit may be configured to initialize the first and second counters, detect the processor has issued and instruction, decrement the first counter in response to the detection of the issued instruction, block the processor from issuing instructions dependent upon the a value of the first counter, reset the first counter dependent upon a value of the second counter, and reset the second counter in response to a determination that the value of the second counter is greater than a pre-determined value.

### BACKGROUND

1. Technical Field

This invention relates to computing systems, and more particularly, to efficiently reducing power consumption through throttling of selected problematic instructions.

2. Description of the Related Art

Geometric dimensions of devices and metal routes on each generation of semiconductor processor cores are decreasing. Therefore, more functionality is provided with a given area of on-die real estate. As a result, mobile devices, such as laptop computers, tablet computers, smart phones, video cameras, and the like, have increasing popularity. Typically, these mobile devices receive electrical power from a battery including one or more electrochemical cells. Since batteries have a limited capacity, they are periodically connected to an external source of energy to be recharged. A vital issue for these mobile devices is power consumption. As power consumption increases, battery life for these devices is reduced and the frequency of recharging increases.

As the density of devices increases on an integrated circuit with multiple pipelines, larger cache memories, and more complex logic, the amount of capacitance that may be charged or discharged in a given clock cycle significantly increases, resulting in higher power consumption. Additionally, a software application may execute particular computer program code that may cause the hardware to reach a high power dissipation value. Such program code could do this either unintentionally or intentionally (e.g., a power virus). The power dissipation may climb due to multiple occurrences of given instruction types within the program code, and the power dissipation may reach or exceed the thermal design power (TDP) or, in some cases, the maximum power dissipation, of an integrated circuit.

In addition to the above, a mobile device's cooling system may be design for a given TDP, or a thermal design point. The cooling system may be able to dissipate a TDP value without exceeding a maximum junction temperature for an integrated circuit. However, multiple occurrences of given instruction types may cause the power dissipation to exceed the TDP for the integrated circuit. Further, there are current limits for the power supply that may be exceeded as well. If power modes do not change the operating mode of the integrated circuit or turn off particular functional blocks within the integrated circuit, the battery may be quickly discharged. In addition, physical damage may occur. One approach to managing peak power dissipation may be to simply limit instruction issue to a pre-determined threshold value, which may result in unacceptable computing performance.

In view of the above, efficient methods and mechanisms for reducing power consumption through issue throttling of selected instructions are desired.

### SUMMARY OF THE EMBODIMENTS

Various embodiments of a circuit and method for implementing instruction throttling are disclosed. Broadly speaking, an apparatus and a method are contemplated in which a control circuit is coupled to a first counter and a second counter. The second counter may be configured to increment in response to the completion of a processing cycle of a processor. The control circuit may be configured to initialize the first and second counters, detect the issue of an instruction by the processor, decrement the first counter dependent upon the detection of the issued instruction, and block the processor from issuing instructions dependent upon a value of the first counter. The control circuit may be further configured to reset the first counter dependent upon the value of the second counter, and reset the second counter in response to a determination that a value of the second counter is greater than a pre-determined value.

In one embodiment, the control circuit may be further configured to load a maximum power credit value into the first counter.

In a further embodiment, the control circuit may be further configured to send at least one signal to a reservation station included in the processor.

### BRIEF DESCRIPTION OF THE DRAWINGS

The following detailed description makes reference to the accompanying drawings, which are now briefly described.

FIG. 1 illustrates an embodiment of a system on a chip.

FIG. 2 illustrates an embodiment of a processor.

FIG. 3 illustrates an embodiment of a multi-processor system with throttle control.

FIG. 4 illustrates an embodiment of a throttle control circuit.

FIG. 5 illustrates a flowchart depicting an embodiment of a method for operating a throttle control circuit.

FIG. 6 illustrates a flowchart depicting an embodiment of a method for adjusting a maximum number of power credits.

FIG. 7 illustrates a flowchart depicting an embodiment of another method for adjusting a maximum number of power credits.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component. More generally, the recitation of any element is expressly intended not to invoke 35 U.S.C. §112, paragraph six interpretation for that element unless the language “means for” or “step for” is specifically recited.

### DETAILED DESCRIPTION OF EMBODIMENTS

To improve computational performance, a system-on-a-chip (SoC) may include multiple processors. While providing additional compute resources, the additional power consumed by each processor while executing instructions may result in a drop in power supply voltage as rapid changes current demand generated by the processors interact within inductive parasitic circuit elements within the SoC and an accompanying package or other mounting apparatus. Some systems attempt to compensate for the rapid changes in current demand through the use of on-die de-coupling capacitors which provide a mechanism for local energy storage on-die. Other systems restrict the number of instructions (commonly referred to as “throttling”) for the processors that result in a large amount switching activity and dynamic power.

Throttling a processor, however, may result in an unacceptable reduction in computational performance. The determination of when to limit the issue of certain instructions is a difficult, and the addition of multiple processors, further complicates the problem. The embodiments illustrated in the drawings and described below may provide techniques for throttling one or more processors while limiting any degradation in computational performance.

### System-on-a-Chip Overview

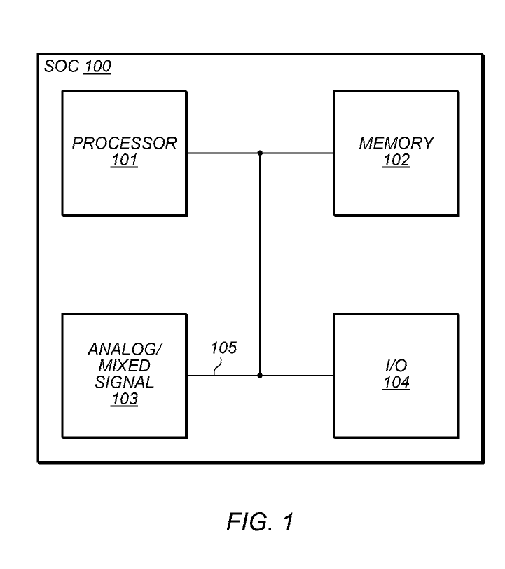

A block diagram of an SoC is illustrated in FIG. 1. In the illustrated embodiment, the SoC 100 includes a processor 101 coupled to memory block 102, and analog/mixed-signal block 103, and I/O block 104 through internal bus 105. In various embodiments, SoC 100 may be configured for use in a mobile computing application such as, e.g., a tablet computer or cellular telephone. Transactions on internal bus 105 may be encoded according to one of various communication protocols.

Memory block 102 may include any suitable type of memory such as a Dynamic Random Access Memory (DRAM), a Static Random Access Memory (SRAM), a Read-only Memory (ROM), Electrically Erasable Programmable Read-only Memory (EEPROM), a FLASH memory, Phase Change Memory (PCM), or a Ferroelectric Random Access Memory (FeRAM), for example. It is noted that in the embodiment of an SoC illustrated in FIG. 1, a single memory block is depicted. In other embodiments, any suitable number of memory blocks may be employed.

As described in more detail below, processor 101 may, in various embodiments, be representative of a general-purpose processor that performs computational operations. For example, processor 101 may be a central processing unit (CPU) such as a microprocessor, a microcontroller, an application-specific integrated circuit (ASIC), or a field-programmable gate array (FPGA).

Analog/mixed-signal block 103 may include a variety of circuits including, for example, a crystal oscillator, a phase-locked loop (PLL), an analog-to-digital converter (ADC), and a digital-to-analog converter (DAC) (all not shown). In other embodiments, analog/mixed-signal block 103 may be configured to perform power management tasks with the inclusion of on-chip power supplies and voltage regulators. Analog/mixed-signal block 103 may also include, in some embodiments, radio frequency (RF) circuits that may be configured for operation with cellular telephone networks.

I/O block 104 may be configured to coordinate data transfer between SoC 100 and one or more peripheral devices. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, I/O block 104 may be configured to implement a version of Universal Serial Bus (USB) protocol or IEEE 1394 (Firewire®) protocol.

I/O block 104 may also be configured to coordinate data transfer between SoC 100 and one or more devices (e.g., other computer systems or SoCs) coupled to SoC 100 via a network. In one embodiment, I/O block 104 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, I/O block 104 may be configured to implement multiple discrete network interface ports.

Each of the functional blocks included in SoC 100 may be included in separate power and/or clock domains. In some embodiments, a functional block may be further divided into smaller power and/or clock domains. Each power and/or clock domain may, in some embodiments, be separately controlled thereby selectively deactivating (either by stopping a clock signal or disconnecting the power) individual functional blocks or portions thereof.

### Processor Overview

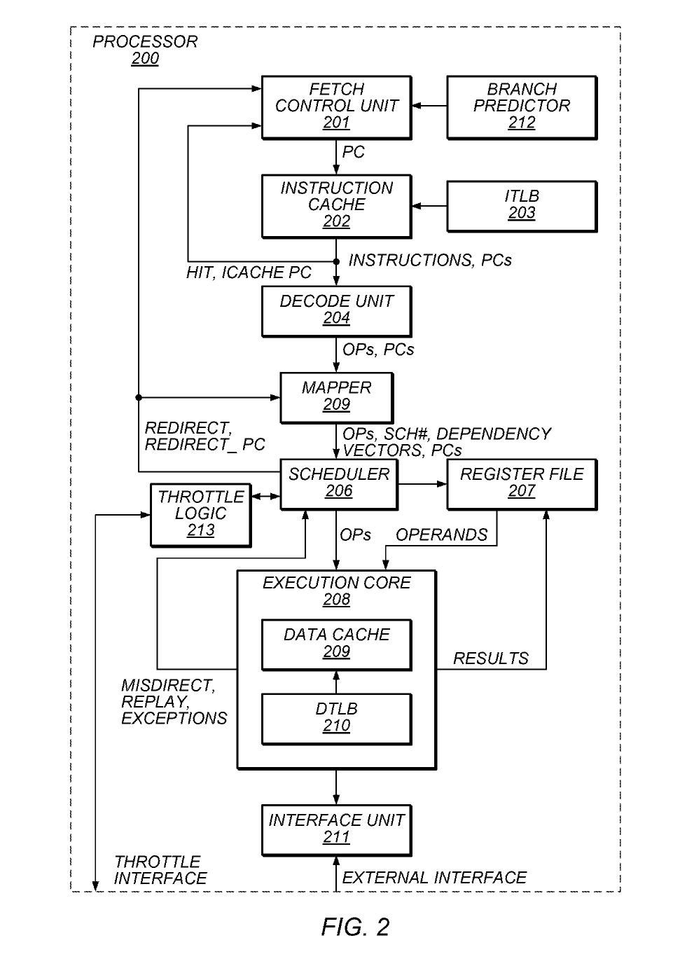

Turning now to FIG. 2, a block diagram of an embodiment of a processor 200 is shown. In the illustrated embodiment, the processor 200 includes a fetch control unit 201, an instruction cache 202, a decode unit 204, a mapper 209, a scheduler 206, a register file 207, an execution core 208, and an interface unit 211. The fetch control unit 201 is coupled to provide a program counter address (PC) for fetching from the instruction cache 202. The instruction cache 202 is coupled to provide instructions (with PCs) to the decode unit 204, which is coupled to provide decoded instruction operations (ops, again with PCs) to the mapper 205. The instruction cache 202 is further configured to provide a hit indication and an ICache PC to the fetch control unit 201. The mapper 205 is coupled to provide ops, a scheduler number (SCH#), source operand numbers (SO#s), one or more dependency vectors, and PCs to the scheduler 206. The scheduler 206 is coupled to receive replay, mispredict, and exception indications from the execution core 208, is coupled to provide a redirect indication and redirect PC to the fetch control unit 201 and the mapper 205, is coupled to the register file 207, and is coupled to provide ops for execution to the execution core 208. The register file is coupled to provide operands to the execution core 208, and is coupled to receive results to be written to the register file 207 from the execution core 208. The execution core 208 is coupled to the interface unit 211, which is further coupled to an external interface of the processor 200.

Fetch control unit 201 may be configured to generate fetch PCs for instruction cache 202. In some embodiments, fetch control unit 201 may include one or more types of branch predictors 212. For example, fetch control unit 202 may include indirect branch target predictors configured to predict the target address for indirect branch instructions, conditional branch predictors configured to predict the outcome of conditional branches, and/or any other suitable type of branch predictor. During operation, fetch control unit 201 may generate a fetch PC based on the output of a selected branch predictor. If the prediction later turns out to be incorrect, fetch control unit 201 may be redirected to fetch from a different address. When generating a fetch PC, in the absence of a nonsequential branch target (i.e., a branch or other redirection to a nonsequential address, whether speculative or non-speculative), fetch control unit 201 may generate a fetch PC as a sequential function of a current PC value. For example, depending on how many bytes are fetched from instruction cache 202 at a given time, fetch control unit 201 may generate a sequential fetch PC by adding a known offset to a current PC value.

The instruction cache 202 may be a cache memory for storing instructions to be executed by the processor 200. The instruction cache 202 may have any capacity and construction (e.g. direct mapped, set associative, fully associative, etc.). The instruction cache 202 may have any cache line size. For example, 64 byte cache lines may be implemented in an embodiment. Other embodiments may use larger or smaller cache line sizes. In response to a given PC from the fetch control unit 201, the instruction cache 202 may output up to a maximum number of instructions. It is contemplated that processor 200 may implement any suitable instruction set architecture (ISA), such as, e.g., PowerPC™, or x86 ISAs, or combinations thereof.

In some embodiments, processor 200 may implement an address translation scheme in which one or more virtual address spaces are made visible to executing software. Memory accesses within the virtual address space are translated to a physical address space corresponding to the actual physical memory available to the system, for example using a set of page tables, segments, or other virtual memory translation schemes. In embodiments that employ address translation, the instruction cache 14 may be partially or completely addressed using physical address bits rather than virtual address bits. For example, instruction cache 202 may use virtual address bits for cache indexing and physical address bits for cache tags.

In order to avoid the cost of performing a full memory translation when performing a cache access, processor 200 may store a set of recent and/or frequently-used virtual-to-physical address translations in a translation lookaside buffer (TLB), such as Instruction TLB (ITLB) 203. During operation, ITLB 203 (which may be implemented as a cache, as a content addressable memory (CAM), or using any other suitable circuit structure) may receive virtual address information and determine whether a valid translation is present. If so, ITLB 203 may provide the corresponding physical address bits to instruction cache 202. If not, ITLB 203 may cause the translation to be determined, for example by raising a virtual memory exception.

The decode unit 204 may generally be configured to decode the instructions into instruction operations (ops). Generally, an instruction operation may be an operation that the hardware included in the execution core 208 is capable of executing. Each instruction may translate to one or more instruction operations which, when executed, result in the operation(s) defined for that instruction being performed according to the instruction set architecture implemented by the processor 200. In some embodiments, each instruction may decode into a single instruction operation. The decode unit 16 may be configured to identify the type of instruction, source operands, etc., and the decoded instruction operation may include the instruction along with some of the decode information. In other embodiments in which each instruction translates to a single op, each op may simply be the corresponding instruction or a portion thereof (e.g. the opcode field or fields of the instruction). In some embodiments in which there is a one-to-one correspondence between instructions and ops, the decode unit 204 and mapper 205 may be combined and/or the decode and mapping operations may occur in one clock cycle. In other embodiments, some instructions may decode into multiple instruction operations. In some embodiments, the decode unit 16 may include any combination of circuitry and/or microcoding in order to generate ops for instructions. For example, relatively simple op generations (e.g. one or two ops per instruction) may be handled in hardware while more extensive op generations (e.g. more than three ops for an instruction) may be handled in microcode.

Ops generated by the decode unit 204 may be provided to the mapper 205. The mapper 205 may implement register renaming to map source register addresses from the ops to the source operand numbers (SO#s) identifying the renamed source registers. Additionally, the mapper 205 may be configured to assign a scheduler entry to store each op, identified by the SCH#. In an embodiment, the SCH# may also be configured to identify the rename register assigned to the destination of the op. In other embodiments, the mapper 205 may be configured to assign a separate destination register number. Additionally, the mapper 205 may be configured to generate dependency vectors for the op. The dependency vectors may identify the ops on which a given op is dependent. In an embodiment, dependencies are indicated by the SCH# of the corresponding ops, and the dependency vector bit positions may correspond to SCH#s. In other embodiments, dependencies may be recorded based on register numbers and the dependency vector bit positions may correspond to the register numbers.

The mapper 205 may provide the ops, along with SCH#, SO#s, PCs, and dependency vectors for each op to the scheduler 206. The scheduler 206 may be configured to store the ops in the scheduler entries identified by the respective SCH#s, along with the SO#s and PCs. The scheduler may be configured to store the dependency vectors in dependency arrays that evaluate which ops are eligible for scheduling. The scheduler 206 may be configured to schedule the ops for execution in the execution core 208. When an op is scheduled, the scheduler 206 may be configured to read its source operands from the register file 207 and the source operands may be provided to the execution core 208. The execution core 208 may be configured to return the results of ops that update registers to the register file 207. In some cases, the execution core 208 may forward a result that is to be written to the register file 207 in place of the value read from the register file 207 (e.g. in the case of back to back scheduling of dependent ops).

The execution core 208 may also be configured to detect various events during execution of ops that may be reported to the scheduler. Branch ops may be mispredicted, and some load/store ops may be replayed (e.g. for address-based conflicts of data being written/read). Various exceptions may be detected (e.g. protection exceptions for memory accesses or for privileged instructions being executed in non-privileged mode, exceptions for no address translation, etc.). The exceptions may cause a corresponding exception handling routine to be executed.

The execution core 208 may be configured to execute predicted branch ops, and may receive the predicted target address that was originally provided to the fetch control unit 201. The execution core 208 may be configured to calculate the target address from the operands of the branch op, and to compare the calculated target address to the predicted target address to detect correct prediction or misprediction. The execution core 208 may also evaluate any other prediction made with respect to the branch op, such as a prediction of the branch op's direction. If a misprediction is detected, execution core 208 may signal that fetch control unit 201 should be redirected to the correct fetch target. Other units, such as the scheduler 206, the mapper 205, and the decode unit 204 may flush pending ops/instructions from the speculative instruction stream that are subsequent to or dependent upon the mispredicted branch.

The execution core may include a data cache 209, which may be a cache memory for storing data to be processed by the processor 200. Like the instruction cache 202, the data cache 209 may have any suitable capacity, construction, or line size (e.g. direct mapped, set associative, fully associative, etc.). Moreover, the data cache 209 may differ from the instruction cache 202 in any of these details. As with instruction cache 202, in some embodiments, data cache 26 may be partially or entirely addressed using physical address bits. Correspondingly, a data TLB (DTLB) 210 may be provided to cache virtual-to-physical address translations for use in accessing the data cache 209 in a manner similar to that described above with respect to ITLB 203. It is noted that although ITLB 203 and DTLB 210 may perform similar functions, in various embodiments they may be implemented differently. For example, they may store different numbers of translations and/or different translation information.

The register file 207 may generally include any set of registers usable to store operands and results of ops executed in the processor 200. In some embodiments, the register file 207 may include a set of physical registers and the mapper 205 may be configured to map the logical registers to the physical registers. The logical registers may include both architected registers specified by the instruction set architecture implemented by the processor 200 and temporary registers that may be used as destinations of ops for temporary results (and sources of subsequent ops as well). In other embodiments, the register file 207 may include an architected register set containing the committed state of the logical registers and a speculative register set containing speculative register state.

Throttle logic 213 may generally include the circuitry for determining the number of certain types of instructions that are being issued through scheduler 206, and sending the gathered data through the throttle interface to a throttle control circuit. In some embodiments, throttle logic 213 may include a table which contains entries corresponding to instruction types that are to be counted. The table may be implemented as a register file, local memory, or any other suitable storage circuit. Additionally, throttle logic 213 may receive control signals from the throttle control circuit through the throttle interface. The control signals may allow throttle logic 213 to adjust how instructions are scheduled within scheduler 206 in order to limit the number of certain types of instructions that can be executed.

The interface unit 211 may generally include the circuitry for interfacing the processor 200 to other devices on the external interface. The external interface may include any type of interconnect (e.g. bus, packet, etc.). The external interface may be an on-chip interconnect, if the processor 200 is integrated with one or more other components (e.g. a system on a chip configuration). The external interface may be on off-chip interconnect to external circuitry, if the processor 200 is not integrated with other components. In various embodiments, the processor 200 may implement any instruction set architecture.

### Instruction Throttling

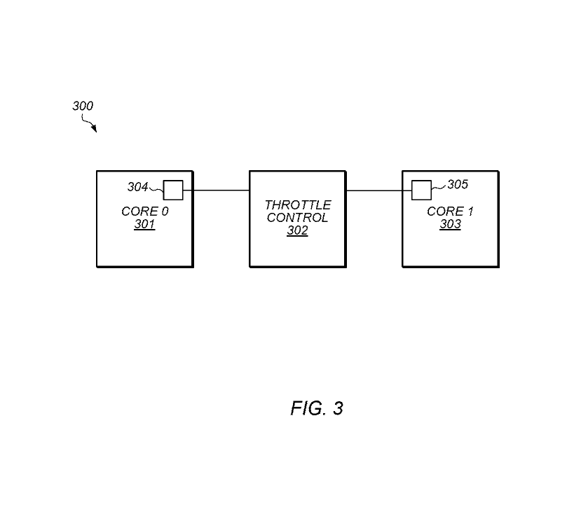

Turning to FIG. 3, an embodiment of a multi-processor system is illustrated. In the illustrated embodiment, system 300 includes processor core 301, processor core 303, and throttle circuit 302. In some embodiments, system 300 may be included in an SoC such as, SoC 100 as illustrated in FIG. 1, for example. Processor cores 301 and 303 may, in other embodiments, correspond to processor 101 of SoC 100 as depicted in the embodiment illustrated in FIG. 1.

Processor core 301 includes throttle circuit 304, and processor core includes throttle circuit 305. In some embodiments, throttle circuit 304 and throttle circuit 305 may detect the issue of high power instructions in processor core 301 and processor core 303, respectively. High power instructions may include one or more instructions from a set of instructions supported by a processor that have been previously identified as generating high power consumption during execution. For example, a floating-point (FP), single-instruction-multiple-data (SIMD) instruction type may have wide data lanes for processing vector elements during a multi-cycle latency. Data transitions on such wide data lanes may contribute to high switching power during the execution of such an instruction.

Reservation stations 304 and 305 may transmit information indicative of the number and type of pending instructions processor core 301 and 303, respectively, to throttle circuit 303. Throttle circuit 302 may estimate the power being consumed by processor core 301 and processor core 303 based on the received information from throttle circuits 304 and 305. Based on the power estimate, throttle circuit 302 limit (also referred to herein as “throttle”) the number of high power instructions being issued in processor core 301 and processor core 303. In some embodiments, throttle circuit 302 may adjust a number of instructions that may be issued in upcoming cycles dependent upon the information received from reservation stations 304 and 305. The number of instructions may be increased or decreased in response to pending instructions in order to limit rapid changes in power consumption. Through the limitation of rapid changes in power consumption, some embodiments may avoid resonance points in a package sub-system, thereby reducing momentary reduction in power supply voltage (commonly referred to as “droop” or “power supply droop”).

In some embodiments, throttle control circuit 302 may set the same limit on the number of instructions to be issued for both processor core 301 and processor core 303. Throttle control circuit 302 may, in other embodiments, set one limit on the number of instructions to be issued for processor core 301, and set a different limit on the number of instructions to be issued for processor core 303.

It is noted that the embodiment of a system illustrated in FIG. 3 is merely an example. In other embodiments, different numbers of processor cores and throttle control circuits may be employed.

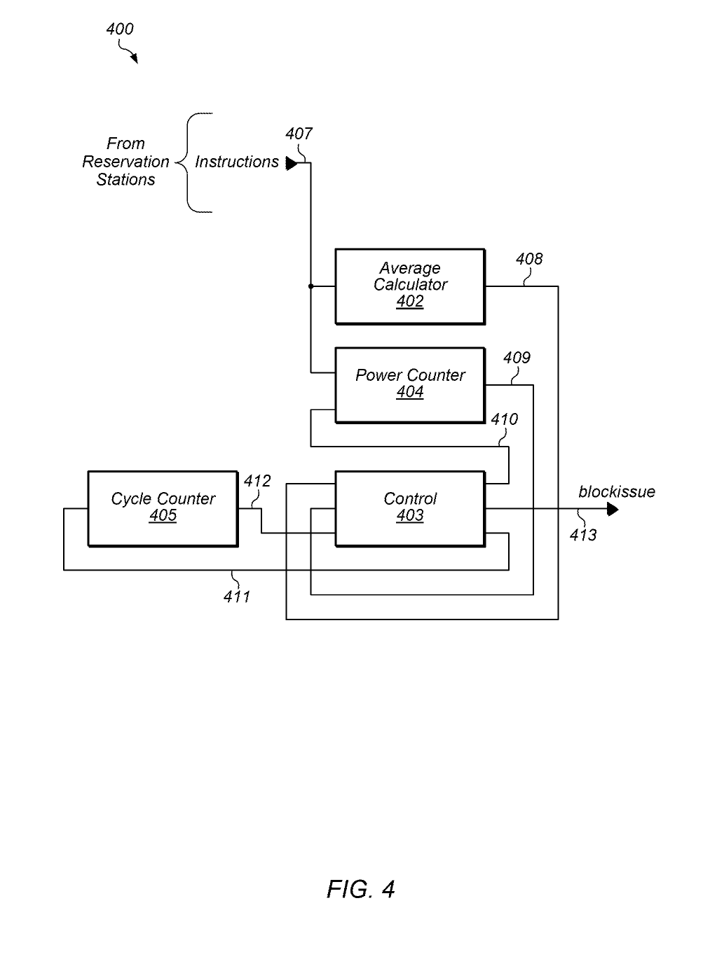

An embodiment of a throttle control circuit is illustrated in FIG. 4. In some embodiments, throttle control circuit 400 may correspond to throttle control circuit 302 of system 300 as illustrated in FIG. 3. In the illustrated embodiment, throttle control circuit 400 includes average power calculator 402, control logic 403, power counter 404, and cycle counter 405.

Average calculator 402 may, in various embodiments, be configured to maintain a moving average of consumed power based on instructions issued by one or more processor cores such as, e.g., processor cores 301 and 303 as illustrated in FIG. 3. In some embodiments, power information for each received instruction may also be received from a reservation station, such as, e.g., reservation station 304 or 30 as illustrated in FIG. 3. Moving average 408 may be accumulated over a pre-determined number of processor cycles. In some embodiments, the number of cycles over which the moving average is accumulated may vary during operation. A Linear Feedback Shift Register (LFSR), or any other suitable sequential logic circuit, may be employed by average calculator 402 in some embodiments, to avoid aliasing (i.e., the inability to distinguish between power values for issued instructions). In various embodiments, average calculator 402 may be implemented as a dedicated sequential logic circuit or any other suitable processing element.

Power counter 404 may be configured, in various embodiments, to track a number of power credits consumed during a cycle window. A cycle window may include one or more processing cycles of a processor. In various embodiments, the number of cycles included in the cycle window may be a function of a maximum number of instructions that may be performed within a single cycle. Power counter 404 may, in some embodiments, be configured to count down from a pre-determined number of power credits, which may be generated by a control circuit such as, e.g., control circuit 403, and sent power counter 404 via power credit signal 410. In other embodiments, power counter 404 may be configured to count up to the pre-determined value. When power counter 404 detects an end condition such as, e.g., the pre-determined power credits have been decremented to zero, maximum power signal 409 may be asserted.

Counters as described and used herein may be a specific embodiment of a sequential logic circuit which is designed to transition between a set of pre-defined logical states in a pre-determined order in order to note a number of times a particular event or process has occurred. A counter may be implemented according to one of various design styles such as, e.g., asynchronous ripple counters, synchronous counters, ring counters, and the like. In some embodiments, a counter may be configured so a value of the counter may be reset or initialized to a know value. The reset or initialization may, in various embodiments, be performed in a synchronous or asynchronous fashion.

Cycle counter 405 may be configured, in various embodiments, to not the number of times a processing cycle of a processor has occurred. In some embodiments, cycle counter 405 may increment upon the completion of each processing cycle until a pre-determined number of cycles has been completed (a “cycle window”) at which point cycle counter 405 may assert cycle window completion signal 412. The pre-determined number of cycles may, in various embodiments, be adjusted by control circuit 403.

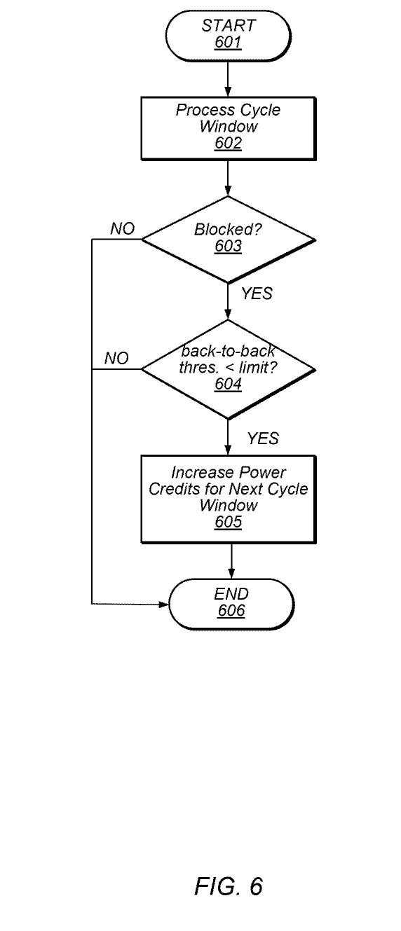

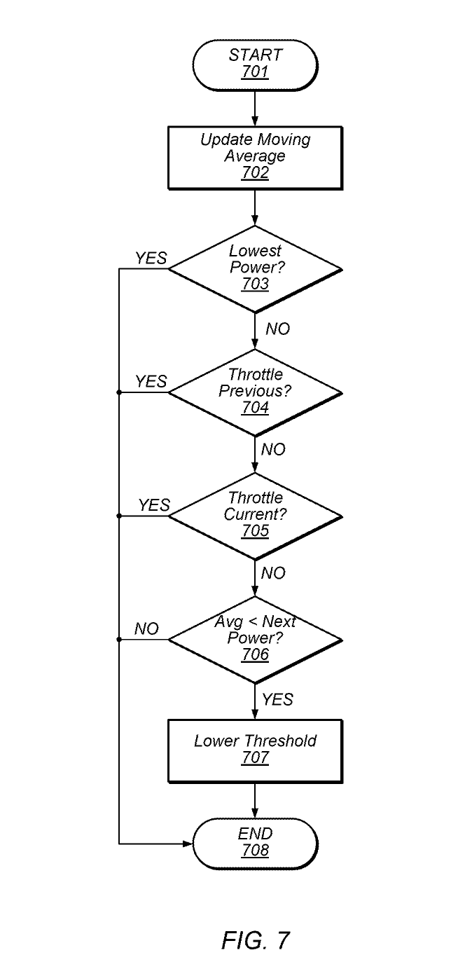

In various embodiments, control circuit 403 may be configured to generated block issue command 413 in response power counter 404 signaling via maximum power signal 409. Block issue command 413 may, in some embodiments, signal to one or more reservation stations to prevent further issuing of instructions within a processor. As will be described below in reference to FIG. 6 and FIG. 7, control circuit 403 may be further configured to adjust a pre-determined maximum number of power credits that may be consumed during a given cycle window. In some embodiments, control circuit 403 may receive moving average 408 which may be used in conjunction with the current state of clock issue command 413, the state of block issue command 413 from a previous cycle window, and a current power mode to determine an adjust to the pre-determined maximum number of power credits.

Control circuit 403 may be implemented according to one of various design styles. In some embodiments, control circuit 403 may be implemented as a dedicated logic circuit while, in other embodiments, control circuit 403 may be implemented as a general purpose processor executing program instructions stored in a memory (not shown).

It is noted that the embodiment illustrated in FIG. 4 is merely an example. In other embodiments, different functional blocks or different configurations of functional blocks are possible and contemplated.

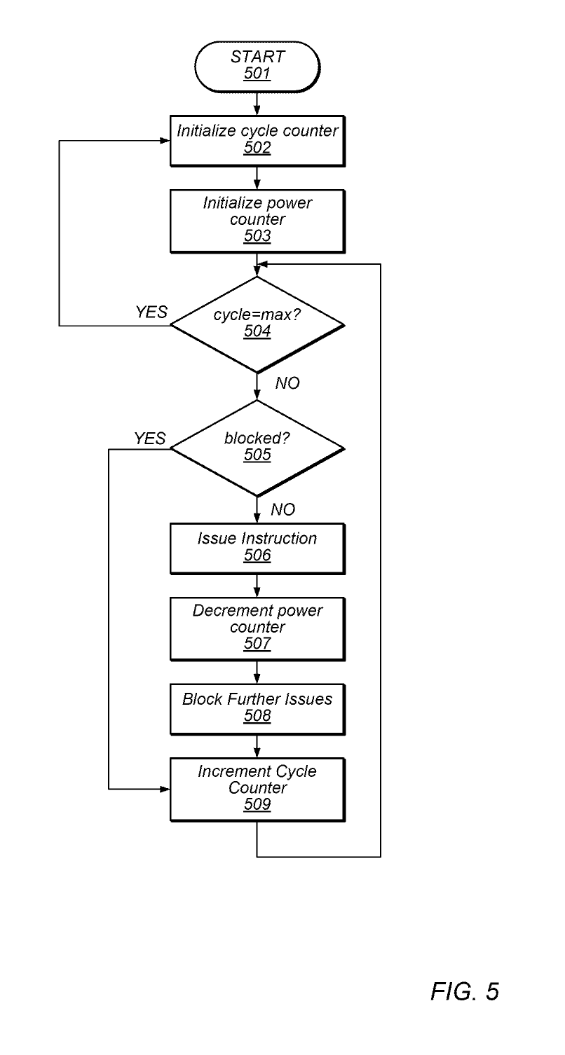

Turning to FIG. 5, a flowchart depicting a method of operating a throttle circuit such as, e.g., throttle circuit 400, included in a computing system is illustrated. Referring collectively to throttle circuit 400 as illustrated in FIG. 4 and the flowchart depicted in FIG. 5, the method begins in block 501. Cycle counter 405 may then be initialized (block 502). In some embodiments, control circuit 403 may load a starting value into cycle counter 405 while, in other embodiments, cycle counter 405 may be configured to reset in response to a command from control circuit 403.

Once cycle counter 403 has been initialized, power counter 404 may then be initialized (block 503). In various embodiments, a pre-determined maximum number of power credits may be loaded into power counter 404 by control circuit 403. A different maximum number of power credits may be loaded into power counter 404 for each cycle window (i.e., a collection of two or more processing cycles). The method then depends on the number of cycles that have been processed (block 504).

When a value of cycle counter 405 is equal to a pre-determined number of cycles, a cycle window has been completed and the method may proceed from block 502 as described above. When the value of cycle counter 405 is less than the pre-determined number of cycles, the method may then depend on whether control circuit 403 has activated block issue command 413 (block 505). When block issue command 413 has been activated, cycle counter 405 may then be incremented (block 509). In some embodiments, cycle counter 405 may incremented in a synchronous fashion while, in other embodiments, cycle counter 405 may be incremented in an asynchronous fashion. Once cycle counter 405 has been incremented, the method may then proceed as described above in reference to block 504.

When block issue command 413 has not been asserted, an instruction may then be issued (block 506). In some embodiments, multiple instructions from respective reservation stations included within respective processors may be issued. Power counter 404 may then be decremented in response to the issuance of the instruction (block 507). In various embodiments, the issued instruction may also be used by average calculator 402 to update a running average of power being consumed by the computing system as described below in more detail in reference to FIG. 7.

Once power counter 404 has been decremented, the method may then depend control circuit 403 may assert block issue command 413 to prevent any further instructions from issuing during the remaining portion of the current cycle window (block 508). In some embodiments, block issue command 413 may remain asserted until the end of the current cycle window at which point a logic state of a storage circuit such as, e.g., a flip-flop or latch, may be changed to indicate that block issue command 413 had been asserted. The state of the storage circuit may then be used in adjusting the value of maximum number of power credits as described below in more detail in reference to FIG. 7. Once block issue command 413 has been asserted, the method may then proceed from block 509 as described above.

It is noted that the method illustrated in FIG. 5 is merely an example. In other embodiments, different operations and different orders of operations are possible and contemplated.

An embodiment of a method for adjusting a number of maximum power credits of a throttle circuit, such as, e.g., throttle circuit 400 as illustrated in FIG. 4, to adjust a power threshold is depicted in FIG. 6. Referring collectively to throttle circuit and the flowchart illustrated in FIG. 6, the method begins in block 601. A cycle window may then be processed (block 602) to determine if the further issuance of instructions needs to be blocked or halted. In some embodiments, the cycle window may be processed using the method depicted in the flowchart illustrated in FIG. 5. In other embodiments, other methods of processing a cycle window may be employed.

Once the cycle window has been processed, control logic 403 may then check to determine if instruction issue has been blocked (block 603). When it is determined that during the cycle window (i.e., a number of processing cycles of one or more processors, such as, e.g., processor 101 of SoC 100 as illustrated in FIG. 1), no instructions were blocked, the method concludes (block 606). In some embodiments, the determination of if the issuance of instructions was blocked may be responsive to a number of power credits being greater than a pre-determined threshold value. The pre-determined threshold value may, in various embodiments, be zero credits, or any other suitable threshold value.

When it is determined that during the course of the cycle window, that the issuance of instructions was blocked, the method may depend on if a number of power credits measured over back-to-back cycles are greater than a pre-determined threshold limit (block 604). In some embodiments, the back-to-back threshold value may be zero, or any other suitable value. When the number of back-to-back power credits is less than the pre-determined threshold limit, the method may conclude (block 606).

When the number of back-to-back power credits is greater than or equal the pre-determined threshold limit, a number of power credits for the next cycle window may then be increased (block 604). In some embodiments, the new number of power credits may be loaded into power counter 404 or any other suitable logic circuit capable of tracking the number of power credits as credits are consumed through the execution of instructions.

In some embodiments, the number of power credits may be increased by a pre-determined value. The pre-determined value may, in various embodiments, be dependent upon a maximum number of instructions that may be performed within a given processor cycle. In other embodiments, a maximum power level may be divided into a number of power levels (also referred to herein as “threshold levels” or “power thresholds”), such that each level power level may correspond a number of power credits.

Once the new number of power credits has been determined, the method may then conclude in block 605. It is noted that the method depicted in the flowchart illustrated in FIG. 6 is merely an example. In other embodiments, different operations and different orders of operations are possible and contemplated.

Turning to FIG. 7, another method for adjusting a maximum number of power credits for a throttle circuit, such as, e.g., throttle circuit 400, included in a computing system is depicted. Referring collectively to throttle circuit 400 of FIG. 4 and the flowchart illustrated in FIG. 7, the method begins in block 701. Average calculator 402 may then update the moving average of the current consumption (block 702). In some embodiments, average calculator 402 may receive instructions which have been issued from a reservation station while, in other embodiments, a power value for each received instruction may also be received. Average calculator 402 may, in various embodiments, employ a linear feedback shift register or other suitable sequential logic to vary a number of cycles over which the running average is calculated. In some embodiments, the use of a varying number of cycles over which to determine the running average may reduce situations where power numbers for the various issued instructions become indistinguishable (commonly referred to as “aliasing”).

Once the running average of the power has been updated, the method may then depend on a current operational state of the system (block 703). When control circuit 402 determines that the system is already operating in its lowest power mode, the method may then conclude in block 708. When control circuit 403 determines that the system is operating is not operating in its lowest power mode, the method may then depend on if instruction throttling (i.e., the issue of one or more instructions was blocked) was performed in a previous cycle window (block 704). In some embodiments, a cycle window immediately preceding a current cycle window may be used in the determination while, in other embodiments, instruction throttling in multiple previous cycle windows may be examined.

When control circuit 402 determines that instruction throttling was performed in a previous cycle window, the method may then conclude in block 708. When control circuit 403 determined that instruction throttle was not performed in the previous cycle window, the method may then depend on if instruction throttling is being performed in a current cycle window (block 705). In cases where control circuit 403 determines that instruction throttling is being performed in the current cycle window, the method may then conclude in block 708.

In situations where instruction throttling is not being performed in the current cycle window, the method may then depend on a comparison between the running average of the power and a lower power mode (block 706). In some embodiments, the lower power mode may be one of multiple power modes each of which may correspond to a maximum number of power credits that may be consumed within a cycle window. Each possible maximum number of power credits may correspond to a number of instructions that may be issued within the cycle window. When control circuit 403 determines that the running average of the power is greater than or equal to a desired lower power level, the method may then conclude in block 707. If, however, control circuit 403 determines that the running average of the power is less than the desired lower power level, control circuit 403 may then lower a power threshold value (block 707). In some embodiments, the lower power threshold value may correspond to a maximum number of power credits that may be consumed during a cycle window. Control circuit 403 may, in various embodiments, load the maximum number of power credits corresponding to the lower power threshold into power counter 404 at the start of a next cycle window. Once the power threshold has been decreased, the method may conclude in block 708.

It is noted that the operations of the method illustrated in the flowchart of FIG. 7 are depicted as being performed in a sequential fashion. In other embodiments, one or more of the operations may be performed in parallel.

Numerous variations and modifications will become apparent to those skilled in the art once the above disclosure is fully appreciated. It is intended that the following claims be interpreted to embrace all such variations and modifications.

What is claimed is:

1. An apparatus, comprising:
a first counter configured to count a number of power credits;
a second counter configured to increment responsive to completion of a processing cycle of a processor; and
a control circuit coupled to the power credit counter and the cycle counter, wherein the control circuit is configured to:
initialize the first counter;
initialize the second counter;
detect an issue of an instruction in the processor;
decrement the first counter dependent upon the detection of the issue of the instruction;
block the processor from issuing instructions dependent upon a value of the first counter;
reset the power credit counter dependent upon a value of the second; and
reset the second counter responsive to a determination that the value of the second counter is greater than a pre-determined value.

2. The apparatus of claim 1, wherein to initialize the first counter, the control circuit is further configured to load a maximum power credit value into the first counter.

3. The apparatus of claim 1, wherein to block the processor from issuing instructions, the control circuit is further configured to send at least one signal to a reservation station included in the processor.

4. The apparatus of claim 1, further comprising an average power calculation unit configured to calculate an average power dependent upon the instruction issued by the processor.

5. The apparatus of claim 1, wherein the control circuit is further configured to increase the maximum power credit value dependent upon the blocking the processor from issuing instructions.

6. The apparatus of claim 4, wherein the control circuit is further configured to decrease the maximum power credit value dependent upon the average power.

7. The apparatus of claim 4, further comprising a power weight unit coupled to the average power calculation unit, wherein the power weight unit is configured to scale a power value for the instruction.

8. A method, comprising:
initializing a number of power credits with a maximum number of power credits;
determining a cycle window has not completed;
determining instruction issuing is not blocked;
issuing one or more instructions dependent upon the determination that the cycle window has not completed and the determination that instruction issuing is not blocked;
decrementing the number of power credits responsive to the issuing of the instruction;
activating blocking of instructing issuing responsive to a determination that the number of power credits is less than or equal to a pre-determined threshold; and
resetting the number of power credits to the maximum number of power credits responsive to a determination that the cycle window has completed.

9. The method of claim 8, further comprising calculating an average power dependent upon the issued one or more instructions.

10. The method of claim 9, wherein calculating the average power comprising scaling a power value for each instruction of the issued one or more instructions.

11. The method of claim 8, further comprising increasing the maximum number of power credits responsive to activating the blocking of instruction issuing.

12. The method of claim 9, further comprising decreasing the maximum number of power credits dependent upon the calculated average power.

13. The method of claim 12, wherein decreasing the maximum number of power credits is further dependent upon if activating the blocking of instruction issuing occurred during a preceding cycle window.

14. The method of claim 13, wherein decreasing the maximum number of power credits is further dependent upon if activating the blocking of instruction issuing occurred during a current cycle window.

15. A system, comprising:
a first processor;
a second processor; and
a throttle control circuit, wherein the throttle control circuit is configured to:
determine a cycle window has not completed;
determine instruction issuing is not blocked;
issue one or more instructions dependent upon the determination that the cycle window has not completed and the determination that instruction issuing is not blocked;
decrement a number of available power credits responsive to the issuing of the instruction;
activate blocking of instructing issuing responsive to a determination that the number of available power credits is greater than a pre-determined threshold; and
reset the number of available power credits responsive to a determination that the cycle window has completed.

16. The system of claim 15, wherein to decrement the number of available power credits, the throttle control circuit is further configured to decrement a value of a first counter.

17. The system of claim 16, wherein to reset the number of available power credits, the throttle control circuit is further configured to set the value of the first counter to a pre-determined value.

18. The system of claim 15, wherein to determine the cycle window has completed, the throttle control circuit is further configured to compare a value of a second counter to a maximum number of cycles.

19. The system of claim 15, wherein the throttle control circuit is further configured to calculate an average power dependent upon the issued one or more instructions.

20. The system of claim 19, wherein to calculate the average power, the throttle circuit is further configured to scale a power value for each instruction of the issued one or more instructions.
